(19) United States
(12) Patent Application Publication
(10) Pub. No.: US 2017/0201756 A1
(43) Pub. Date: Jul. 13, 2017

(54) VIDEO DECODING METHOD

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: YING-HAN CHEN, New Taipei (TW)

(21) Appl. No.: 15/008,596

(22) Filed: Jan. 28, 2016

(30) Foreign Application Priority Data
Jan. 7, 2016 (TW) 105100439

(51) Int. Cl. H04N 19/176; H04N 19/46; H04N 19/172

(52) U.S. Cl. CPC H04N 19/176; H04N 19/172; H04N 19/46

(57) ABSTRACT

A video encoding method includes steps of: determining how many cores of one or more processors are capable of processing video frames; identifying a number of parallel processable frames according to types of video frames; and determining when the determination is that the number of the parallel processable frames is greater than or equal to the number of the cores of the processors which can process the video frames, frame level parallel decoding the parallel processable frames and, when the determination is that the number of the parallel processable frames is less than the number of cores of the processors, which can process video frames, retaining one parallel processable frame to be parallel decoded at a macroblock level, and the other parallel processable frames to be parallel decoded at a frame level.

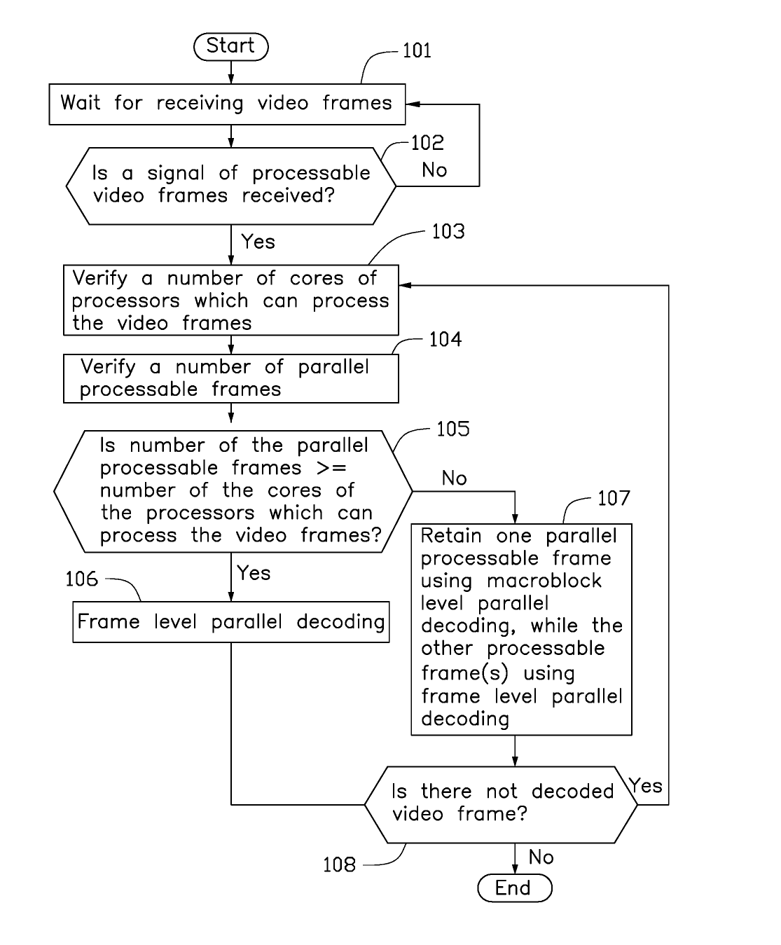

### FIELD

The subject matter herein generally relates to a video decoding method.

### BACKGROUND

To enhance video encoding efficiency, improving algorithm or leveraging multicore processors is typically provided, and the multicore processors generally parallel encode video either at a frame level or at a macroblock level.

### BRIEF DESCRIPTION OF THE DRAWINGS

Implementations of the present technology will now be described, by way of example only, with reference to the figures.

The FIGURE is a flowchart of an embodiment of a video encoding method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like.

The present disclosure described in relation to a video decoding method.

The FIGURE is a flowchart of an embodiment of a video encoding method.

At block 101, a plurality of threads of processors waits for receiving video frames.

At block 102, a determination is made whether a signal of processable video frames is received. If yes, the processing proceeds to step 103. If no, the processing returns to step 101 to continue waiting for receiving video frames.

At block 103, a number of cores of processors which can process the video frames is verified.

At block 104, according to types of the video frames, a number of parallel processable frames of the video frames is verified.

At block 105, a determination is made whether the number of the parallel processable frames is greater than or equal to the number of the cores of the processors which can process the video frames. If yes, the processing proceeds to step 106. If no, the processing proceeds to step 107.

At block 106, the parallel processable frames are distributed to the threads of the processors which can process the video frames, to be parallel decoded at a frame level. For example, there are three parallel processable frames and three cores of the processors can process the video frames, the three frames can be distributed to the three cores of the processors to be parallel decoded at a frame level.

At block 107, the parallel processable frames are distributed to the threads of the processors which can process the video frames, retaining one parallel processable frame to be parallel decoded at a macroblock level, while the other parallel processable frame(s) to be parallel decoded at a frame level. For example, there are three parallel processable frames and four cores of the processors can process the video frames, two of the frames can be distributed to two of the cores to be parallel decoded at a frame level, and the other frame can be distributed to the other two of the cores to be parallel decoded at a macroblock level. For another example, there is one parallel processable frame and four cores of the processors can process the video frames, the frame is distributed to the four cores to be parallel decoded at a macroblock level.

At block 108, a determination is made whether there is a not decoded video frame. If yes, the processing returns to step 103. If no, the processing is end.

In the above process, the order of block 103 and block 104 can be reversed. At block 108, if a determination is made that there is a not decoded video frame, the processing returns to the prior block of the block 103 and block 104.

Exemplary Embodiments are described below.

### Embodiment 1

A plurality of threads of processors waits for receiving video frames. When a signal of video frames IPBBPBBPBBIBB is received, the processors determine there are four cores can process the video frames. The four cores of processors inspect four video frames at a time.

The four cores of processors read the first video frame I and inspect frames IPBB, because the second frame is P type, only the first video frame I can be parallel processed, the number of parallel processable frame is one. The number of the cores is four, more than the number of parallel processable frame, so the first video frame I is parallel decoded at a macroblock level.

Then, the four cores of processors read the second video frame P and inspect frames PBBP, because the third frame is B type, only the second video frame P can be parallel processed, the number of parallel processable frame is one. The number of the cores is four, more than the number of parallel processable frame, so the second video frame P is parallel decoded at a macroblock level.

Then, the four cores of processors read the third video frame B and inspect frames BBPB, finds the third, fourth, and fifth video frames BBP can be parallel processed. The number of parallel processable frames is three. The number of the cores is four, more than the number of parallel processable frames, so the video frame B is parallel decoded at a macroblock level, and the other two video frames BP are parallel decoded at a frame level.

Then, the four cores of processors read the sixth video frame B and inspect frames BBPB, finds the sixth, seventh, and eighth video frames BBP can be parallel processed. The number of parallel processable frames is three. The number of the cores is four, more than the number of parallel processable frames, so the video frame B is parallel decoded at a macroblock level, and the other two video frames BP are parallel decoded at a frame level. If in the process, the number of cores of processors which can process the video frames is verified changed to three, the number of the cores is equal to the number of parallel processable frames, the three video frames BBP are parallel decoded at a frame level.

Later, the processing returns back to continue decoding the rest video frames until there is no video frame.

### Embodiment 2

A plurality of threads of processors waits for receiving video frames. When a signal of video frames IPBBPBBPBBIBB is received, the processors determine there are two cores of processors which can process the video frames. The two cores of processors inspect two video frames at a time.

The two cores of processors read the first video frame I and inspect frames IP, because the second frame is P type, only the first video frame I can be parallel processed, the number of parallel processable frame is one. The number of the cores is two, more than the number of parallel processable frame, so the first video frame I is parallel decoded at a macroblock level.

Then, the two cores of processors read the second video frame P and inspect frames PB, because the third frame is B type, only the second video frame P can be parallel processed, the number of parallel processable frame is one. The number of the cores is two, more than the number of parallel processable frame, so the second video frame P is parallel decoded at a macroblock level.

Then, the two cores of processors read the third video frame B and inspect frames BB, finds the third and fourth video frames BB can be parallel processed. The number of parallel processable frames is two. The number of the cores is two, equal to the number of parallel processable frames, so the two video frames BB are parallel decoded at a frame level.

When anyone of the two video frames BB is decoded, the two cores of processors read the fifth video frame P and inspect frames PB, because the sixth frame is B type, only the fifth video frame P can be parallel processed, the number of parallel processable frame is one. Now, the number of cores which can process the video frames is one, equal to the number of parallel processable frames, so the fifth video frame P is parallel decoded at a frame level.

Later, the processing returns back to continue decoding the rest video frames until there is no video frame.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A video encoding method comprising:
determining how many cores of one or more processors are capable of processing video frames;
identifying a number of parallel processable frames according to types of video frames; and
determining when the determination is that the number of the parallel processable frames is greater than or equal to the number of the cores of the processors which can process the video frames, frame level parallel decoding the parallel processable frames and, when the determination is that the number of the parallel processable frames is less than the number of cores of the processors, which can process video frames, retaining one parallel processable frame to be parallel decoded at a macroblock level, and the other parallel processable frames to be parallel decoded at a frame level.

2. The video encoding method of claim 1, further comprising steps before the step verifying a number of cores of processors which is capable of processing video frames:
a plurality of threads of processors waiting for receiving video frames; and
determining when the determination is that a signal of processable video frames is received, processing the step determining how many cores of one or more processors are capable of processing video frames and, when the determination is that there is no signal of processable video frame is received, returning to the step waiting for receiving video frames.

3. The video encoding method of claim 2, further comprising a step after decoding the parallel processable frame:
determining whether there is a not decoded video frame, if yes, returning to the step determining how many cores of one or more processors are capable of processing video frames, if no, the processing is end.

4. A video encoding method comprising:
identifying a number of parallel processable frames according to types of video frames;
determining how many cores of one or more processors are capable of processing video frames; and
determining when the determination is that the number of the parallel processable frames is greater than or equal to the number of the cores of the processors which can process the video frames, frame level parallel decoding the parallel processable frames and, when the determination is that the number of the parallel processable frames is less than the number of cores of the processors, which can process video frames, retaining one parallel processable frame to be parallel decoded at a macroblock level, and the other parallel processable frames to be parallel decoded at a frame level.

5. The video encoding method of claim 4, further comprising steps before the step verifying a number of parallel processable frames according to types of the video frames:
a plurality of threads of processors waiting for receiving video frames; and
determining when the determination is that a signal of processable video frames is received, processing the step identifying a number of parallel processable frames according to types of video frames and, when the determination is that there is no signal of processable video frame is received, returning to the step waiting for receiving video frames.

6. The video encoding method of claim 4, further comprising a step after decoding the parallel processable frame:
determining whether there is a not decoded video frame, if yes, returning to the step identifying a number of parallel processable frames according to types of video frames, if no, the processing is end.
